(19) United States
(12) Patent Application Publication
(10) Pub. No.: US 2019/0369007 A1
(43) Pub. Date: Dec. 5, 2019

(54) MICROFLUIDIC CHIP AND MICROFLUIDIC SYSTEM

(71) Applicant: BOE Technology Group Co., Ltd., Beijing (CN)

(72) Inventors: Jifeng Tan, Beijing (CN); Xianqin Meng, Beijing (CN); Wei Wang, Beijing (CN); Xiandong Meng, Beijing (CN); Xiaochuan Chen, Beijing (CN)

(73) Assignee: BOE Technology Group Co., Ltd., Beijing (CN)

(21) Appl. No.: 16/267,834

(22) Filed: Feb. 5, 2019

(30) Foreign Application Priority Data
May 31, 2018 (CN) 201810552833.7

(51) Int. Cl. G01N 21/25; G01N 21/31

(52) U.S. Cl. CPC G01N 21/255; G01N 2201/0635; G01N 21/31

(57) ABSTRACT

The present disclosure provides a microfluidic chip and a microfluidic system. The microfluidic chip includes: a droplet flow passage; at least two grating regions that are disposed along a length direction of the droplet flow channel and have different grating constants; a light source disposed at a first end of the droplet flow channel along the length direction of the droplet flow channel and configured to provide incident light rays of different wavelengths; and a wavelength detector used to detect reflected light rays or transmitted light rays of the incident light rays passing through the at least two grating regions.

### CROSS-REFERENCE TO RELATED APPLICATION

This application is based on and claims priority of Chinese Patent Application No. 201810552833.7, filed on May 31, 2018, which is incorporated herein by reference in its entirety.

### TECHNICAL FIELD

The present disclosure relates to the field of microfluidic technology, and in particular to a microfluidic chip and a microfluidic system.

### BACKGROUND

One microfluidic system generally includes a microfluidic chip for realizing specific functions, a microfluidic operation control device, and a signal acquisition control-detection device. The microfluidic operation control device is at an outside of the microfluidic chip, and may include a microfluidic detection system for detecting liquid parameters. The liquid parameters may include a positon, a shape, a flow rate, a contact angle, etc. However, with increasing demand of detection in the field of biomedicine, one technical solution that uses the above microfluidic detection system to detect droplets in the microfluidic chip has been somewhat inferior.

### SUMMARY

According to a first aspect, one embodiment of the present disclosure provides a microfluidic chip that includes: a droplet flow passage; at least two grating regions that are disposed along a length direction of the droplet flow channel and have different grating constants; a light source disposed at a first end of the droplet flow channel along the length direction of the droplet flow channel and configured to provide incident light rays of different wavelengths; and a wavelength detector configured to detect reflected light rays or transmitted light rays of the incident light rays passing through the at least two grating regions.

In one embodiment, the wavelength detector is disposed at the first end, and is configured to detect the reflected light rays of the incident light rays passing through the at least two grating regions.

In one embodiment, the wavelength detector is disposed at a second end of the droplet flow channel along the length direction of the droplet flow channel; the first end and the second end are opposite ends of the droplet flow channel along the length direction of the droplet flow channel; the wavelength detector is configured to detect the transmitted light rays of the incident light rays passing through the at least two grating regions.

In one embodiment, the droplet flow channel and the at least two grating regions are disposed at different layers that are adjacent each other, respectively; and each of the at least two grating regions extends from one side of the droplet flow channel along a width direction of the droplet flow channel to another side of the droplet flow channel along the width direction of the droplet flow channel.

In one embodiment, the droplet flow channel and the at least two grating regions are disposed at an identical layer; and at least one side of the droplet flow channel is provided with the light source, the at least two grating regions and the wavelength detector.

In one embodiment, the light source, the at least two grating regions and the wavelength detector are disposed at each of opposite sides of the droplet flow channel; the light source, the at least two grating regions and the wavelength detector disposed at one of the opposite sides of the droplet flow channel, and the at least two grating regions and the wavelength detector disposed at the other one of the opposite sides of the droplet flow channel are symmetrically arranged with respect to the droplet flow channel.

In one embodiment, an interval between adjacent grating regions is less than a width of the droplet flow channel.

In one embodiment, the interval between adjacent grating regions is in a range of from 20 microns to 100 microns.

In one embodiment, a width of each grating region in a direction perpendicular to the length direction of the droplet flow channel is equal to a width of the droplet flow channel in the length direction of the droplet flow channel.

In one embodiment, the width of each grating region is in a range of from 20 microns to 100 microns.

In one embodiment, the microfluidic chip further includes a hydrophobic layer at an inner wall of the droplet flow channel.

In one embodiment, the droplet flow passage and the at least two grating regions are in an identical substrate or in two different substrates.

In one embodiment, the substrate that defines the droplet flow channel is made of resin or silicon on insulator (SOI) of a high refractive index.

In one embodiment, the substrate that defines the droplet flow channel is made of material of a high refractive index.

According to a second aspect, one embodiment of the present disclosure provides a microfluidic system that includes a microfluidic controller and the above microfluidic chip. The microfluidic controller is electrically connected with the wavelength detector of the microfluidic chip.

In one embodiment, the microfluidic controller is an industrial computer.

### BRIEF DESCRIPTION OF THE DRAWINGS

A brief introduction will be given hereinafter to the accompanying drawings which will be used in the description of the embodiments in order to explain the embodiments of the present disclosure more clearly. Apparently, the drawings in the description below are merely for illustrating some embodiments of the present disclosure. Those skilled in the art may obtain other drawings according to these drawings without paying any creative labor.

FIG. 1 is a schematic view of a microfluidic chip in the related art;

FIG. 2 is a schematic cross-sectional view of a microfluidic chip according to an embodiment of the present disclosure;

FIG. 3 is a top view of a microfluidic chip according to an embodiment of the present disclosure;

FIG. 4 is a schematic view showing detection of a position of a droplet according to an embodiment of the present disclosure;

FIG. 5 is a schematic view showing an optical path according to an embodiment of the present disclosure;

FIG. 6 is a schematic view showing another optical path according to an embodiment of the present disclosure;

FIG. 7 is a top view of a microfluidic chip according to another embodiment of the present disclosure;

FIG. 8 is a top view of a microfluidic chip according to another embodiment of the present disclosure; and

FIG. 9 is a schematic view showing detection of a contact angle of a droplet according to an embodiment of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise indicated. The following description of exemplary embodiments is merely used to illustrate the present disclosure and is not to be construed as limiting the present disclosure.

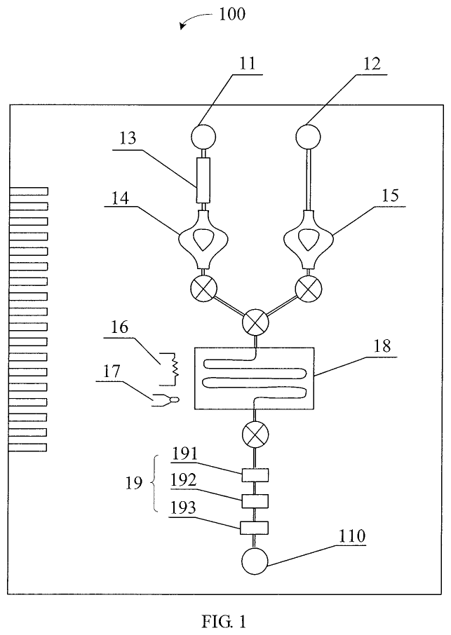

As shown in FIG. 1, in related art, a microfluidic chip 100 generally incudes a sample inlet 11, a reagent entrance 12, a dielectrophoresis (DEP) filter 13, pumps 14-15, a heater 16, a resistance temperature detector (RTD) 17, a polymerase chain reaction (PCR) chamber 18, an electrode 19 and an outlet 110. The electrode 19 includes a counter electrode 1991, a working electrode 192 and a reference electrode 193. The microfluidic chip generally does not include a detection system for detecting liquid parameters that may include a positon, a shape, a flow rate, a contact angle, etc. The detection of liquid in the microfluidic chip depends entirely on an outside microfluidic detection system. However, with increasing demand of detection in the field of biomedicine, one technical solution that uses the above microfluidic detection system to detect droplets in the microfluidic chip has been somewhat inferior.

In view of this, embodiments of the present disclosure provide a microfluidic chip and a microfluidic system, which can improve detection accuracy of a droplet in the microfluidic chip, thereby realizing accurate control of droplets.

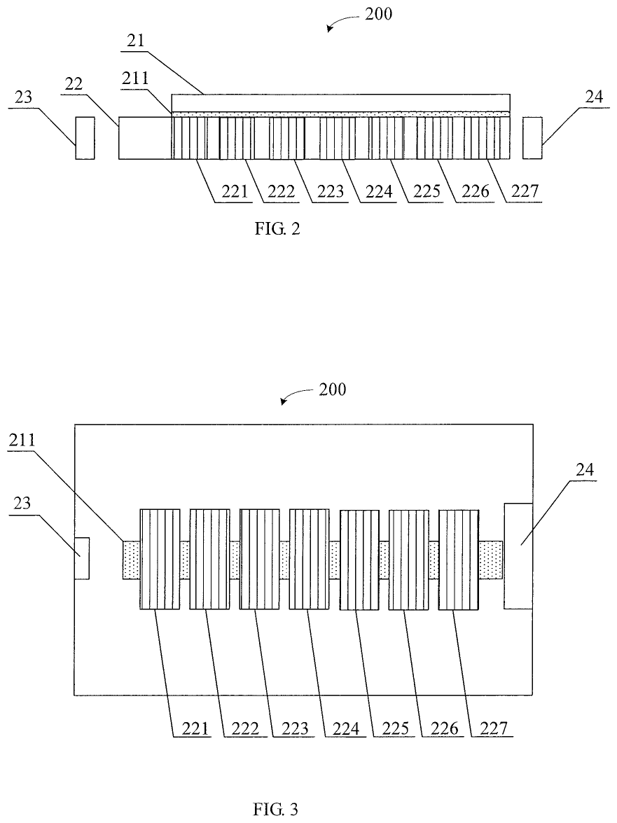

FIG. 2 to FIG. 8 show a microfluidic chip according to an embodiment of the present disclosure. The microfluidic chip 200 includes a droplet flow passage 211, at least two grating regions 221-227, a light source 23 and a wavelength detector 24.

As shown in FIG. 2 to FIG. 8, the droplet flow passage 211 and the at least two grating regions 221-227 are in an identical substrate 25 or in different substrates 21-22. The at least two grating regions 221-227 are arranged along a length direction of the droplet flow channel 211.

Grating constants of the at least two grating regions 221-227 are different from each other. When there is no liquid droplet in the droplet flow channel 211, the at least two grating regions 221-227 are used to reflect light rays of different specified wavelengths, respectively. When there is a liquid droplet in the droplet flow channel 211, a wavelength of light rays reflected by the grating region corresponding to a position of the liquid droplet, is different form the specified wavelength.

As shown in FIG. 2, the light source 23 is disposed at a first end of the droplet flow channel 211 along the length direction of the droplet flow channel 211, and is used to provide incident light rays. The incident light rays include the light rays of different specified wavelengths. When the wavelength detector 24 is disposed at the first end, the wavelength detector is used to detect reflected light rays of the incident light rays passing through the at least two grating regions 221-227.

When the wavelength detector 24 is disposed at a second end of the droplet flow channel 211 along the length direction of the droplet flow channel 211 and the first end and the second end are opposite ends of the droplet flow channel 211 along the length direction of the droplet flow channel 211, the wavelength detector is used to detect transmitted light rays of the incident light rays passing through the at least two grating regions 221-227.

Benefic effects of this embodiment are as follow. The at least two grating regions of different grating constants are disposed along the length direction of the droplet flow channel; the at least two grating regions are used to reflect light rays of different specified wavelengths when there is no liquid droplet in the droplet flow channel; and a wavelength of light rays reflected by the grating region corresponding to a position of the liquid droplet when there is a liquid droplet in the droplet flow channel, is different form the specified wavelength. The wavelength detector which is disposed at the same end as the light source, is used to detect reflected light rays of the incident light rays passing through the at least two grating regions, or the wavelength detector which is disposed at an opposite end to the light source, is used to detect transmitted light rays of the incident light rays passing through the at least two grating regions. Through information carried in the above reflected light rays or transmitted light rays, parameters of the liquid droplet can be detected accurately, thereby realizing accurate control of the liquid droplet.

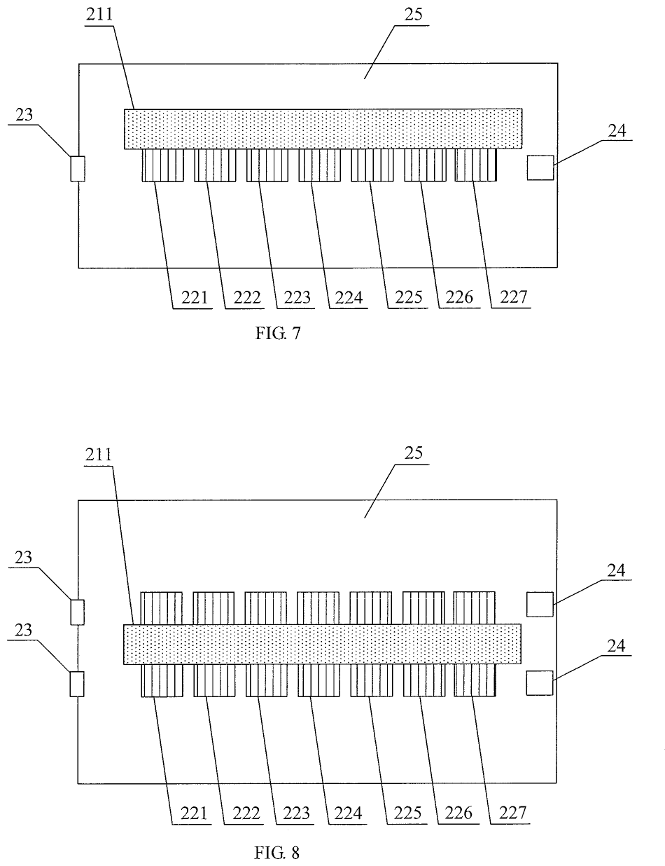

As shown in FIG. 2 and FIGS. 4-5, in one example, the droplet flow channel 211 and the at least two grating regions 221-227, may be disposed at two adjacent substrates 21 and 22, respectively. Specifically, the droplet flow channel 211 is in the first substrate 21, and the at least two grating regions 221-227 may be disposed at the second substrate 22. As shown in FIG. 7 and FIGS. 8-9, in another example, the droplet flow channel 211 and the at least two grating regions 221-227 may be disposed at the same substrate 25, which helps to reduce a thickness of the entire device.

As shown in FIG. 2 and FIGS. 4-5, seven grating regions 221-227 may be disposed at the second substrate 22, and are used to light rays of wavelengths λ1˜λ7, respectively. The wavelengths λ1˜λ7 each may be a single wavelength or a certain wavelength range. The light source 23 is disposed at the first end of the droplet flow channel 211 along the length direction of the droplet flow channel 211, and is used to provide collimated incident light rays. The light source 23 may include an ULED or a laser chip. The wavelength detector 24 is disposed at the second end of the droplet flow channel 211 along the length direction of the droplet flow channel 211 and the first end and the second end are opposite ends of the droplet flow channel 211 along the length direction of the droplet flow channel 211. The light source 23 is used to emit the light rays of wavelengths λ1˜λ7 towards the grating regions 221-227. The wavelength detector 24 is used to detect transmitted light rays of the incident light rays passing through the grating regions 221-227, thereby obtaining a spectrum of the transmitted light.

As shown in FIG. 2, when there is no liquid droplet in the droplet flow channel 211, the seven grating regions 221-227 reflect light rays of wavelengths λ1˜λ7 backwards, respectively. Then, the wavelength detector 24 cannot detect light rays of wavelengths λ1˜λ7. In other words, there are no light rays of wavelengths λ1˜λ7 in the obtained spectrum. In this way, based on the detection result from the wavelength detector 24, it can be determined that there is no liquid droplet at each of positions corresponding to the seven grating regions 221-227, respectively.

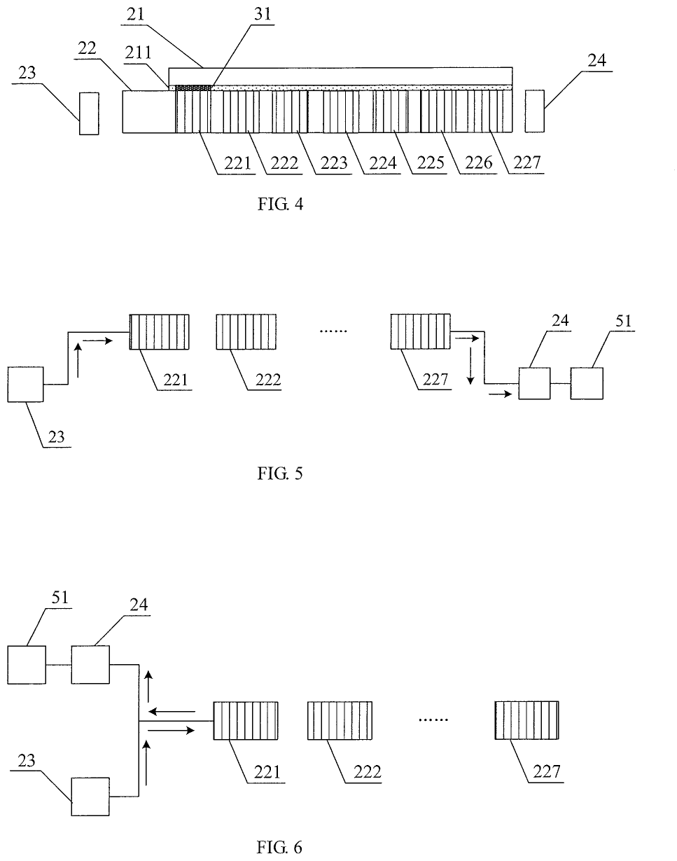

As shown in FIG. 4, when there is a liquid droplet in the droplet flow channel 211, for example, there is a liquid droplet at a position corresponding to the grating region 221, the grating region 221 may reflect light rays of wavelength λ1+Δλ but does not reflect light rays of wavelength λ1. Thus, the light rays of wavelength λ1 can sequentially pass through the grating regions 221-227, and then the wavelength detector 24 can detect light rays of wavelength λ1. In other words, there are light rays of wavelength λ1 in the obtained spectrum. In this way, based on the detection result from the wavelength detector 24, it can be determined that there is a liquid droplet at the position corresponding to the grating region 221.

As shown in FIG. 5 and FIG. 6, the wavelength detector 24 and the light source 23 may be disposed at two ends of the droplet flow channel 211 along the length direction of the droplet flow channel 211, respectively. In some embodiments, the wavelength detector 24 and the light source 23 may also be disposed at an identical end of the droplet flow channel 211 along the length direction of the droplet flow channel 211. Specifically, as shown in FIG. 5, in one embodiment, the light source 23 is disposed at the first end of the droplet flow channel 211 along the length direction of the droplet flow channel 211, and the wavelength detector 24 is disposed at the second end of the droplet flow channel 211 along the length direction of the droplet flow channel 211, i.e., the wavelength detector 24 and the light source 23 are disposed at two ends of the droplet flow channel 211 along the length direction of the droplet flow channel 211, respectively. The wavelength detector 24 is used to detect transmitted light rays of the incident light rays passing through the at least two grating regions 221-227.

As shown in FIG. 6, in one embodiment, the wavelength detector 24 and the light source 23 both are disposed at the first end of the droplet flow channel 211 along the length direction of the droplet flow channel 211. The wavelength detector 24 is used to detect reflected light rays of the incident light rays passing through the at least two grating regions 221-227. When there is no liquid droplet in the droplet flow channel 211, the seven grating regions 221-227 reflect light rays of wavelengths λ1˜λ7 backwards, respectively. Then, the wavelength detector 24 can detect light rays of wavelengths λ1˜λ7. In this way, based on the detection result from the wavelength detector 24, it can be determined that there is no liquid droplet at each of positions corresponding to the seven grating regions 221-227, respectively. When there is a liquid droplet in the droplet flow channel 211, for example, there is a liquid droplet at a position corresponding to the grating region 221, the grating region 221 may reflect light rays of wavelength λ1+Δλ but does not reflect light rays of wavelength λ1. Thus, the light rays of wavelength λ1 can sequentially pass through the grating regions 221-227, and then the wavelength detector 24 cannot detect light rays of wavelength λ1. In this way, based on the detection result from the wavelength detector 24, it can be determined that there is a liquid droplet at the position corresponding to the grating region 221.

As shown in FIG. 2 and FIG. 3, in one example, the droplet flow channel 211 and the at least two grating regions 221-227, may be disposed at different layers that are adjacent each other, respectively. Specifically, a group of grating regions 221-227 may be disposed at the second substrate 22, there is one light source 23 and there is one wavelength detector 24. The light source 23 may be oriented towards the droplet flow channel 211. The grating regions each have an identical length. A length of the wavelength detector 24 may be equal to the length of each grating region. As shown in FIG. 2, the first substrate 21 and the second substrate 22 are disposed at different layers, i.e., the droplet flow channel 211 and the grating regions 221-227, are disposed at different layers. As shown in FIG. 3, each grating region extends from one side of the droplet flow channel 211 along a width direction of the droplet flow channel 211 to another side of the droplet flow channel 211 along the width direction of the droplet flow channel 211. In this way, there is a larger contact range between the droplet flow channel 211 and each grating region, and then the wavelength of light rays reflected by the grating region is easily affected due to the presence of liquid droplet in the droplet flow channel 211, thereby improving detection accuracy of a droplet.

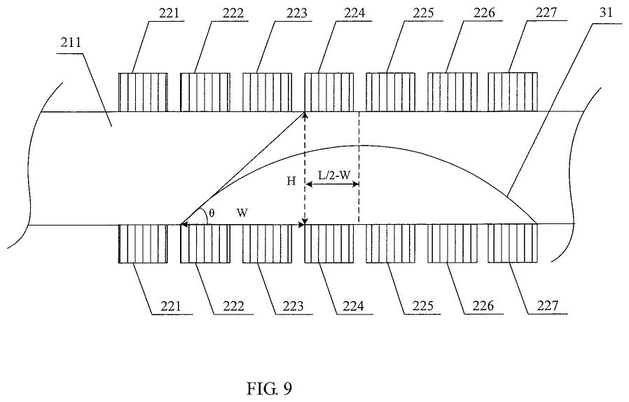

As shown in FIG. 7 and FIG. 8, the droplet flow channel 211 and the at least two grating regions 221-227, may be disposed at an identical layer. At least one side of the droplet flow channel 211 is provided with the light source 23, the at least two grating regions 221-227 and the wavelength detector 24. As shown in FIG. 7, in one example, the droplet flow channel 211 and the at least two grating regions 221-227, may be disposed at a third substrate 25. The third substrate 25 is provided with one group of grating regions 221-227. In this embodiment, there is one light source 23 and there is one wavelength detector 24. The light source 23, the grating regions 221-227 and the wavelength detector 24 are at an identical side of the droplet flow channel 211. In other words, the grating regions 221-227 are at an identical side of the droplet flow channel 211, and the light source 23 and the wavelength detector 24 are oriented towards the grating regions 221-227, respectively, thereby reducing the thickness of the microfluidic chip.

As shown in FIG. 8, in another example, the third substrate 25 is provided with two groups of grating regions 221-227. In this embodiment, the two groups of grating regions 221-227 are disposed at two sides of the droplet flow channel 211, there is two light sources 23 and there are two wavelength detectors 24. Each group of grating regions 221-227 is corresponding to one light source 23 and one wavelength detector 24. In this embodiment, the light sources 23, the grating regions 221-227 and the wavelength detectors 24 are symmetrically arranged with respect to the droplet flow channel 211. In other words, at each of two opposite sides of the droplet flow channel 211, one group of grating regions 221-227 is disposed. In the two groups of grating regions 221-227, grating regions having the same grating constant are disposed at positions opposite to each other. Each group of grating regions 221-227 is corresponding to one light source 23 and one wavelength detector 24. The microfluidic chip shown in FIG. 8 has a reduced thickness, not only can detect positions of liquid droplets, but also can detect a contact angle θ. The contact angle θ may be detected in the following way.

As shown in FIG. 9, the size of the contact angle θ may be obtained through arctan(H/W), where H represents a width of the droplet flow channel 211 and is known, and W is equal to L/2−(L/2−W), and L represents a length of contact between a liquid droplet 31 and the droplet flow channel 211. For ease of description, one side of an inner wall of the droplet flow channel 211 in contact with the liquid droplet 31 is recorded as a first side, and an opposite side of the first side is recorded as a second side. When the liquid droplet 31 is in contact with or close enough to the first side or the second side, wavelength of light rays reflected by the grating region at the position corresponding to the liquid droplet is changed accordingly. As shown in FIG. 9, when the liquid droplet 31 exists, wavelengths of light rays reflected by the grating regions at the first side are changed and not λ2˜λ7. Then, the length L of contact between the liquid droplet 31 and the droplet flow channel 211 can be obtained via calculation based on a width of the grating regions 222-227 and an interval between adjacent grating regions. Similarly, when it is detected that the liquid droplet 31 is further in contact with or close enough to the grating regions 224-225 of the grating regions 221-227 at the second side. Then the above L/2−W can be obtained through the width of the grating region 224. In this way, W is obtained through L/2−(L/2−W). Then, an approximate contact angle θ of the liquid droplet is obtained through arctan(H/W).

In one embodiment, an optical grating of each grating region is a Bragg grating. In case that there is no liquid droplet in the droplet flow channel 211, when light rays pass through the grating regions, light rays of specified wavelengths are reflected following the Bragg reflection principle. When one liquid droplet is injected into the droplet flow channel 211, an effective refractive index n_{eff} of medium around the grating region at the position where the liquid droplet is located, will be changed. Then, when the light rays pass through the grating regions, wavelengths of light rays that are reflected by the grating region at the position where the liquid droplet is located will changed, and wavelengths of light rays that are reflected by the grating region at the position where the liquid droplet is not located is still the specified wavelengths. The principle is that reflection wavelengths of the Bragg grating vary with a grating period and the effective refractive index of the medium outside the grating, that is,

Δλ_{B}=2Δn_{effΛ} (1)

where Δλ_{B} represents a variable of the reflection wavelengths, Δn_{eff} represents a variable of the effective refractive index of the medium around the grating, and Λ represents a wavelength of an incident wave.

In one embodiment, the width of the grating region may be set according to the size and positon of the liquid droplet, the principle that there is a large probability that a diameter of the liquid droplet is equal to the width of the droplet flow channel, or the width of the droplet flow channel. The width of the grating region may be equal to the diameter of the liquid droplet or the width of the droplet flow channel. For instance, the width of the grating region may be in a range of from 20 microns to 100 microns. This helps to improve detection accuracy.

In one embodiment, the interval between adjacent two grating regions may be less than the diameter of the liquid droplet or the width of the droplet flow channel. For instance, the interval between adjacent two grating regions may be in a range of from 20 microns to 100 microns. This helps to improve detection accuracy.

In one embodiment, a hydrophobic layer may be provided at the inner wall of the droplet flow channel 211. The hydrophobic layer may be provided at the inner wall of the droplet flow channel 211 by means of coating. This facilitates the liquid droplet to flow in the droplet flow channel 211.

In one embodiment, the substrate that defines the droplet flow channel, may be made of material of a high refractive index, thereby enabling the droplet flow channel 211 to form a waveguide. In this way, when there is no liquid droplet in the droplet flow channel 211, the incident light rays can be totally reflected and propagated in the droplet flow channel 211, thereby avoiding reduction of accuracy of the wavelength detector caused by attenuation during optical transmission and then improving detection accuracy of parameters of the liquid droplet.

In an exemplary embodiment, the substrate that defines the droplet flow channel 211, may be made of resin or silicon on insulator (SOI) of a high refractive index. When the substrate that defines the droplet flow channel 211, is made SOI, a Si base substrate is used as a base substrate for the droplet flow channel 211, silicon dioxide (SiO₂) and Si layer above SiO₂ are used to manufacture the droplet flow channel 211. The space outside of the droplet flow channel 211 may be air or may be filled other material of a low refractive index. The shape of the droplet flow channel 211 is not limited to the shape shown in embodiments of the present disclose and may be set according to the specific functions of the microfluidic chip.

In an exemplary embodiment, a thickness of the wall of the droplet flow channel 211 may be in a range of 1 micron to 1000 microns.

In the embodiment of the present disclosure, the position and the contact angle of the liquid droplet are detected as an example. In practical applications, the microfluidic chip may also be used to detect other droplet parameters, such as a shape, a refractive index and a flow rate of the liquid droplet. The above microfluidic chip may be used in combination with a microfluidic control system (such as a microfluidic pump or an electro-wetting based chip driver), and realizes accurate measurement and control of the liquid droplet in the microfluidic chip through a specific control algorithm (or chip).

As shown in FIG. 5 and FIG. 6, one embodiment of the present disclosure further provides a microfluidic system that includes a microfluidic controller 51 and the above microfluidic chip 200. The microfluidic controller 51 is electrically connected with the wavelength detector 24 of the microfluidic chip 200.

In one embodiment, the microfluidic controller 51 may be an industrial computer, which can show the position of the detected liquid droplet and control the liquid droplet according to the detected parameters of the liquid droplet.

Benefic effects of this embodiment are as follow. The at least two grating regions of different grating constants are disposed along the length direction of the droplet flow channel; the at least two grating regions are used to reflect light rays of different specified wavelengths when there is no liquid droplet in the droplet flow channel; and a wavelength of light rays reflected by the grating region corresponding to a position of the liquid droplet when there is a liquid droplet in the droplet flow channel, is different form the specified wavelength. The wavelength detector which is disposed at the same end as the light source, is used to detect reflected light rays of the incident light rays passing through the at least two grating regions, or the wavelength detector which is disposed at an opposite end to the light source, is used to detect transmitted light rays of the incident light rays passing through the at least two grating regions. Through information carried in the above reflected light rays or transmitted light rays, parameters of the liquid droplet can be detected accurately, thereby realizing accurate control of the liquid droplet.

The various embodiments in the present disclosure are described in a progressive manner, and each embodiment focuses on differences from other embodiments, and the same similar parts between the various embodiments may be referred to each other.

In addition, terms such as “first” and “second” are used herein for purposes of description and are not intended to indicate or imply relative importance or significance. Thus, features limited by “first” and “second” are intended to indicate or imply including one or more than one these features. In the description of the present disclosure, “a plurality of” relates to two or more than two.

In the above description of the present disclosure, reference to “an embodiment,” “some embodiments,” “one embodiment”, “another example,” “an example,” “a specific example,” or “some examples,” means that a particular feature, structure, material, or characteristic described in connection with the embodiment or example is included in at least one embodiment or example of the present invention. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present invention. Furthermore, the particular features, structures, materials, or characteristics may be combined in any suitable manner in one or more embodiments or examples.

Although explanatory embodiments have been shown and described, it would be appreciated by those skilled in the art that the above embodiments cannot be construed to limit the present invention, and changes, alternatives, and modifications can be made in the embodiments without departing from spirit, principles and scope of the present invention.

What is claimed is:

1. A microfluidic chip comprising:
a droplet flow passage;
at least two grating regions that are disposed along a length direction of the droplet flow channel and have different grating constants;
a light source disposed at a first end of the droplet flow channel along the length direction of the droplet flow channel and configured to provide incident light rays of different wavelengths; and
a wavelength detector configured to detect reflected light rays or transmitted light rays of the incident light rays passing through the at least two grating regions.

2. The microfluidic chip of claim 1, wherein the wavelength detector is disposed at the first end, and is configured to detect the reflected light rays of the incident light rays passing through the at least two grating regions.

3. The microfluidic chip of claim 1, wherein the wavelength detector is disposed at a second end of the droplet flow channel along the length direction of the droplet flow channel; the first end and the second end are opposite ends of the droplet flow channel along the length direction of the droplet flow channel; the wavelength detector is configured to detect the transmitted light rays of the incident light rays passing through the at least two grating regions.

4. The microfluidic chip of claim 1, wherein the droplet flow channel and the at least two grating regions are disposed at different layers that are adjacent each other, respectively; and
each of the at least two grating regions extends from one side of the droplet flow channel along a width direction of the droplet flow channel to another side of the droplet flow channel along the width direction of the droplet flow channel.

5. The microfluidic chip of claim 1, wherein the droplet flow channel and the at least two grating regions are disposed at an identical layer; and at least one side of the droplet flow channel is provided with the light source, the at least two grating regions and the wavelength detector.

6. The microfluidic chip of claim 5, wherein the light source, the at least two grating regions and the wavelength detector are disposed at each of opposite sides of the droplet flow channel; the light source, the at least two grating regions and the wavelength detector disposed at one of the opposite sides of the droplet flow channel, and the at least two grating regions and the wavelength detector disposed at the other one of the opposite sides of the droplet flow channel are symmetrically arranged with respect to the droplet flow channel.

7. The microfluidic chip of claim 1, wherein an interval between adjacent grating regions is less than a width of the droplet flow channel.

8. The microfluidic chip of claim 7, wherein the interval between adjacent grating regions is in a range of from 20 microns to 100 microns.

9. The microfluidic chip of claim 1, wherein a width of each grating region in a direction perpendicular to the length direction of the droplet flow channel is equal to a width of the droplet flow channel in the length direction of the droplet flow channel.

10. The microfluidic chip of claim 9, wherein the width of each grating region is in a range of from 20 microns to 100 microns.

11. The microfluidic chip of claim 1, further comprising a hydrophobic layer at an inner wall of the droplet flow channel.

12. The microfluidic chip of claim 1, wherein the droplet flow passage and the at least two grating regions are in an identical substrate or in two different substrates.

13. The microfluidic chip of claim 12, wherein the substrate that defines the droplet flow channel is made of resin or silicon on insulator (SOI) of a high refractive index.

14. The microfluidic chip of claim 12, wherein the substrate that defines the droplet flow channel is made of material of a high refractive index.

15. A microfluidic system comprising: a microfluidic controller and the microfluidic chip of claim 1; wherein the microfluidic controller is electrically connected with the wavelength detector of the microfluidic chip.

16. The microfluidic system of claim 15, wherein the microfluidic controller is an industrial computer.
